(19) United States
(12) Patent Application Publication
(10) Pub. No.: US 2019/0112848 A1
(43) Pub. Date: Apr. 18, 2019

(54) Mechanism for Operating a Gate Latch Lever

(71) Applicant: Norman Carter, North Bend, WA (US)

(72) Inventor: Norman Carter, North Bend, WA (US)

(21) Appl. No.: 16/158,323

(22) Filed: Oct. 12, 2018

Related U.S. Application Data
(60) Provisional application No. 62/573,650, filed on Oct. 17, 2017.

(51) Int. Cl. E05C 3/30; E05B 53/00; E05C 3/16

(52) U.S. Cl. CPC E05C 3/30; E05C 3/162; E05B 53/003

(57) ABSTRACT

One embodiment of an improved mechanism for operating a gate latch lever has a flexible line extending between two handles, one of which is connected to a gate latch lever (115). A portion of flexible line (107) is sheathed inside a coil spring (108) and traverses through a hole (112) bored horizontally through a gatepost (118). One end of the coil spring is attached to an anchor whose flange portion (105) prevents the coil spring from slipping through the gatepost hole. The other end of the coil spring is attached to the flexible line by a clamp (109). Thus, one can open the gate latch lever using one of the handles positioned on either side of the gatepost, and the tension of the coil spring returns the gate latch lever to its closed position automatically. Other embodiments are described and shown.

### CROSS-REFERENCE TO RELATED APPLICATIONS

This application claims the benefit of Provisional Patent Application Ser. No. 62/573,650, filed 2017 Oct. 17 by the present inventor, which is incorporated by reference.

### BACKGROUND OF THE INVENTION

### Technical Field

The present invention relates to fencing and gate hardware, and more specifically to hardware used for latching and unlatching a gate latch.

### Background—Discussion of the Art

In the field of fencing and gate hardware, many gates are affixed with a horizontally protruding bar which serves to strike the adjacent gatepost as the gate swings closed, limiting range of motion such that the gate can only open in one direction. Many gateposts are affixed with a latch which serves to lock the bar protruding from the gate in place against the gatepost. Many gate latches are comprised of a vertical lever with a pawl. When the lever of such a gate latch is pressed upward, the bar attached to the gate is released from the pawl portion of the gate latch lever, allowing the gate to swing open while the gate latch lever drops back into its closed position. Likewise, when the gate closes, the pawl of the gate latch lever locks the gate bar against the gatepost once the gate latch lever is dropped down into its closed position.

Although commonly used in the industry, this type of gate latch comes with two inherent limitations, the first of which is that to open this type of gate latch, one typically has to reach over the gate and manually pull the gate latch lever upward in order to release the gate bar from the pawl so that the gate can swing open. The second limitation is that the gate latch lever, which is attached to the gatepost, will drop into its closed position too slowly and fail to catch the gate bar when the gate is closed quickly. As a result, one has no choice but to manipulate the gate latch lever manually to successfully operate it.

A mechanism which solves these limitations would need to be comprised of some combination of one or more mechanical components such as springs, flexible lines, tubes, chains, rods and/or levers in order to augment the function and operation of the gate latch lever. However, a difficulty inherent in providing such a mechanism for outdoor use is that over time the component materials will degrade and mechanically fail, increasing the risk of physical harm or material damage to a person attempting to use the mechanism.

For example, some components such as a flexible line made from plastic or organic material will eventually fail when exposed to ultraviolet light, moisture, freezing and/or organic growth such as mildew or moss. Other mechanical components, such as springs or levers, when exposed to outside elements, will fail to operate correctly when debris falls into or onto them, as they will become blocked, bent or broken. As these exposed components degrade, the hazard risk inherent in their continued use increases, such as the increased likelihood of pinching a finger between exposed spring coils, or scratching or poking one's hand or arm or damaging one's clothing on a bent or broken metal part.

A mechanism that attempts solve the above limitations by providing an enclosure for its mechanical components will be bulky by nature and will have multiple points of failure where the components interact with their enclosure. In addition, if the mechanism is designed such that the enclosure surrounding the mechanical components must be hidden within the gatepost, the enclosure will require a hole in the gatepost large enough to accommodate it, therefore requiring a professional with appropriate tools to properly assemble the components and install the mechanism.

The challenge, and area of innovation, is to provide a mechanism that solves these limitations, enabling one to reliably open the gate from either side without reaching over it, and automatically return the gate latch to its closed position reliably, even when the gate is closed quickly. In addition, the mechanism provided must be of simple, durable and compact design, such that the number of components exposed, the effort required for assembly and installation, the size of the footprint required for installation, and the number of points of failure are all minimized.

### BRIEF SUMMARY OF THE INVENTION

The present invention is a mechanism which, when attached an existing gate latch's lever, provides a reliable method of opening the gate latch lever and automatically returning the gate latch lever to its original position with the use of one hand by either pulling a handle from outside the gate or pushing a handle from inside the gate.

### Advantages

The invention provides a durable, compact design with minimal points of failure or exposed components and as such can be packaged in a fully-assembled form which requires no specialized tools for installation.

The invention is described in detail through examples, which describe more than one embodiment included in the scope of the invention.

### BRIEF SUMMARY OF SEVERAL VIEWS OF THE DRAWINGS

Figures include items which are not claimed as part of the invention but are contextually helpful in understanding the nature of the invention, specifically the gatepost (118), hole bored horizontally through the gatepost (112), gate latch lever (115), gate bar (114), gate (117), and hardware for affixing the gate bar to the gate (116).

### DRAWINGS—FIGURES

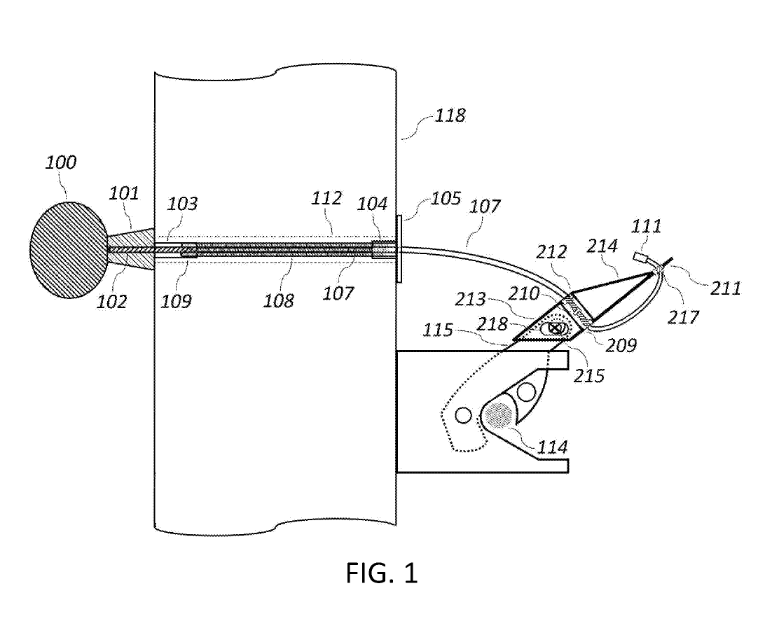

FIG. 1 shows a side view of the mechanism in its closed position, in accordance with one embodiment.

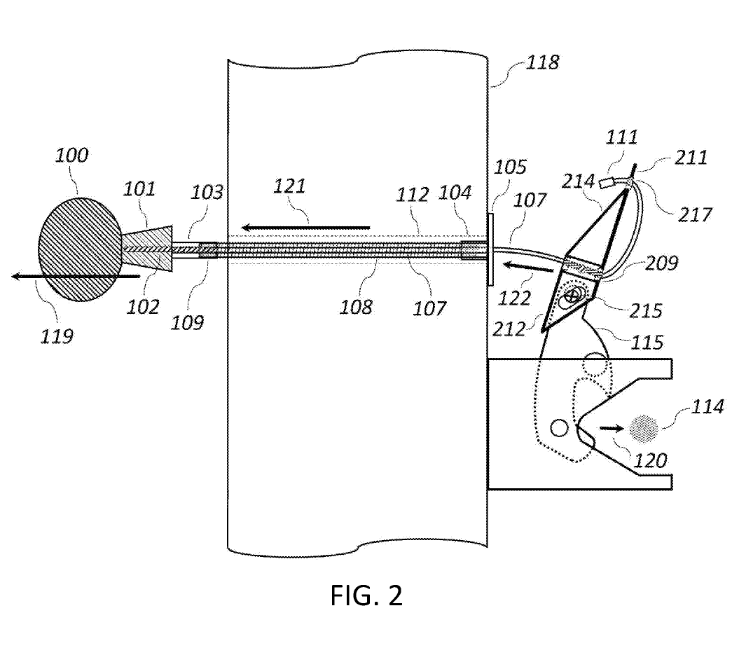

FIG. 2 shows a side view of the mechanism in its opened position, as well as the direction of movement required to move from a closed to an opened position.

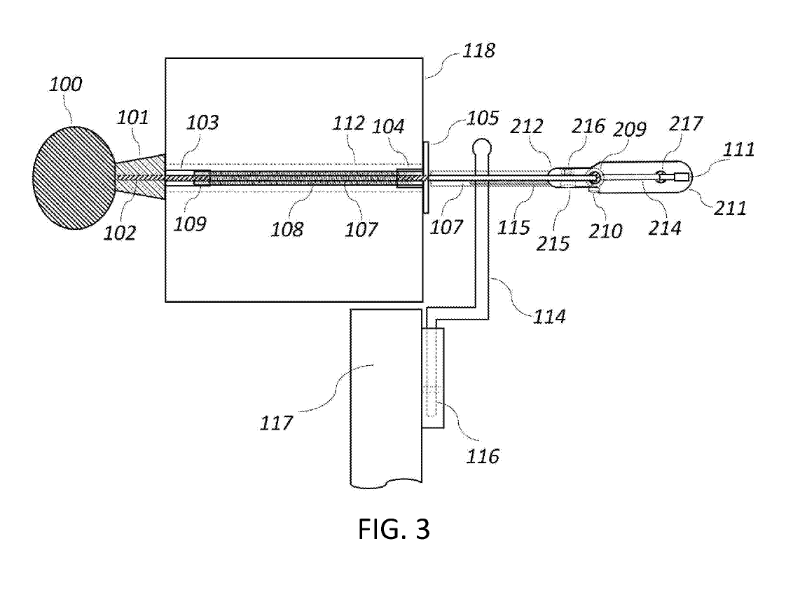

FIG. 3 shows a view of the mechanism from above, in its closed position, in accordance with one embodiment.

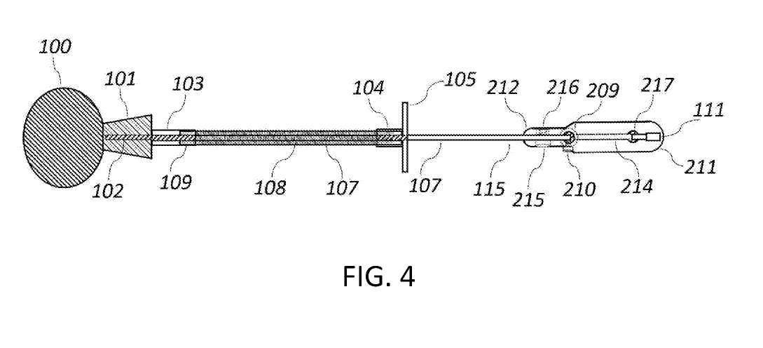

FIG. 4 shows a view of the mechanism from above, in accordance with one embodiment

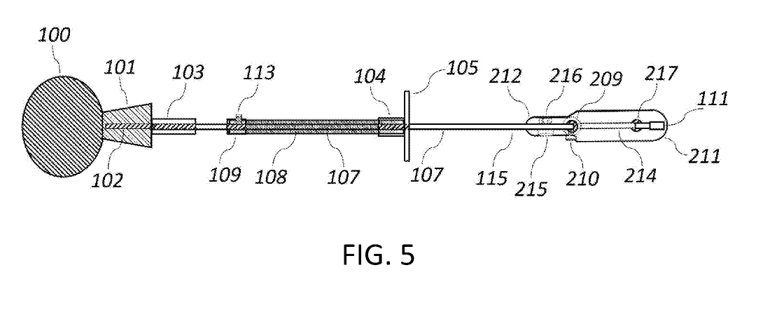

FIG. 5 shows a view of the mechanism from above, in accordance with another embodiment

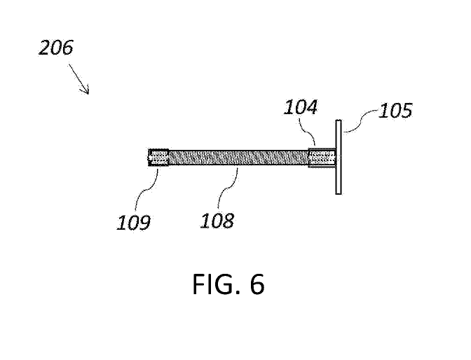

FIG. 6 shows a side of the coil spring assembly, in accordance with one embodiment

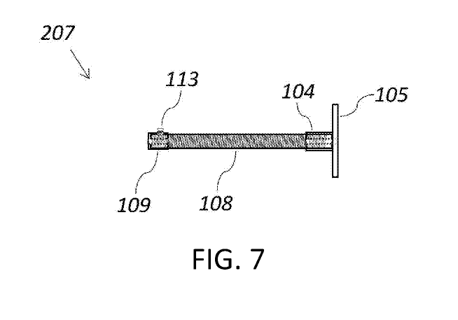

FIG. 7 shows a side of the coil spring assembly, in accordance with another embodiment

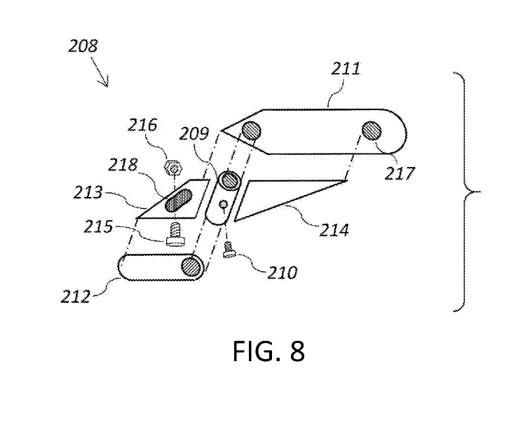

FIG. 8 shows an exploded view of the components of the second handle in accordance with one embodiment

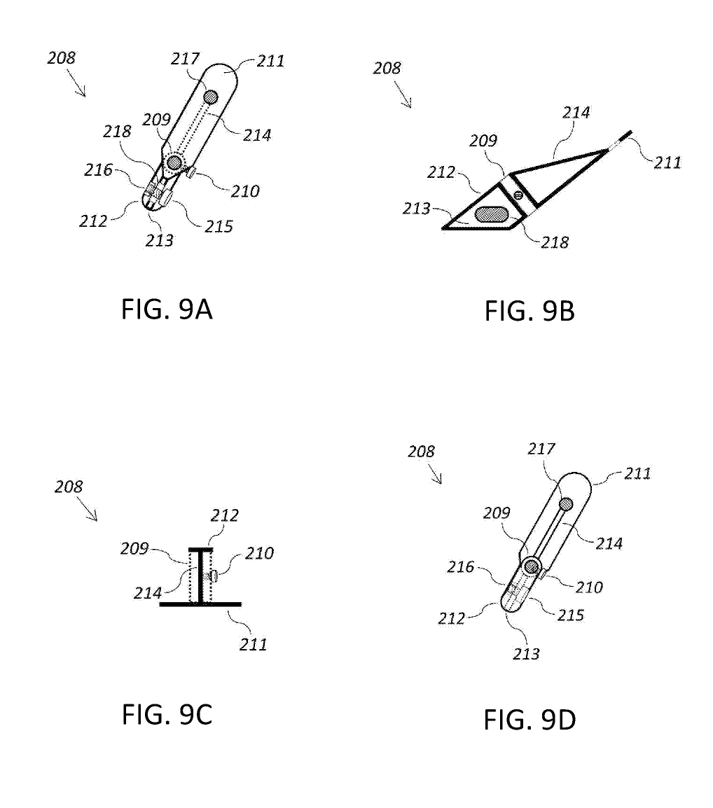

FIGS. 9A, 9B, 9C and 9D show various aspects of the second handle, in accordance with one embodiment

### DRAWINGS—REFERENCE NUMERALS

100 the first handle
101 the stem portion of first handle
102 the threaded stud
103 the stem portion of threaded stud
104 the stem portion of the anchor
105 the flange portion of the anchor
107 the flexible line
108 the coil spring
109 the second clamp
111 the end cap
112 a hole through a gatepost
113 the screw for the second clamp (alternate embodiment)
114 a gate bar
115 a gate latch lever
116 hardware for attaching a gate latch bar to a gate
117 a gate
118 a gatepost
119 the motion of first handle pulling away from the anchor
120 the motion of a gate bar moving away from a gatepost
121 the motion of stretching the coil spring into an extended state
122 the motion pulling the flexible line through the anchor
206 the coil spring assembly with the anchor and the second clamp (one embodiment)
207 the coil spring assembly with the anchor and the second clamp (alternate embodiment)
208 the second handle assembly with the first clamp
209 the first clamp
210 the screw through the side of the first clamp
211 the surface area of the second handle
212 the underside of the second handle
213 the trapezoidal body portion of the second handle
214 the triangular body portion of second handle
215 the screw for the trapezoidal body of the second handle
216 the bolt for the screw for the trapezoidal body of the second handle
217 the second hole in surface area of the second handle
218 the elongated hole in the trapezoidal body portion of the second handle

### DETAILED DESCRIPTION OF THE INVENTION

### Detailed Description—FIGS. 1, 3 and 4

One embodiment of the mechanism for operating a gate latch lever is illustrated in FIG. 1 (side view, with a gatepost and gate latch), FIG. 3 (top view, with a gatepost and gate latch) and FIG. 4 (top view).

The mechanism for operating a gate latch lever has a first handle (100) which has a stem (101) whose central core is threaded to match a threaded stud (102). The threaded stud's stem portion (103) is attached to one end of a flexible line (107). In one embodiment, all components are made from stainless steel and the first handle is made from stainless steel or wood with a stainless steel threaded female insert, and as such the flexible line can be attached to the threaded stud by industry standard means for connecting stainless steel components such as welding and crimping. The flexible line (107) extends through the hole bored through the gatepost (112) and then its length (107) spans the distance between the gatepost (118) and the gate latch lever (115), and then extends through the hollow core of a first clamp (209), which has a cylindrical shape. The first clamp has a hole through its body at a perpendicular angle which is threaded to match a screw (210). The screw (210) is tightened so that it extends perpendicularly through the core of the first clamp and clamps the flexible line.

The first clamp (209) is embedded into the center of a second handle, which has a flat surface area (211) in the form of an elongated plate which runs the length of the second handle and is wide enough to be suitable for pushing with one's thumb. The surface area portion (211) of the second handle has two holes through its face that are the same diameter as the hollow core of the first clamp (209). The first hole is positioned at one end of the surface area (211) plate and is aligned with and connected at a perpendicular angle to the cylindrical rim of the first clamp (209), and the second hole (217) is positioned at the other end of the surface area (211) plate. The second handle also has an underside surface (212) in the form of an elongated plate with a single hole through its face that is the same diameter as the cylindrical rim of the hollow inner core of the first clamp (209), to which it is aligned with and connected to at a perpendicular angle. A trapezoidal body portion (213) of the second handle has a first edge of which is attached to the length of the outer cylindrical wall of the first clamp (209), and a second and third edges which are attached at a perpendicular angle along the median of the interior-facing walls of the surface area (211) and underside (212) portions of the second handle. The trapezoidal body portion (213) has an elongated hole (218) along its fourth edge, which is fastened to the gate latch lever (115) with a screw (215) and bolt (216). The second handle also has a triangular body portion (214), the first edge of which is attached to the length of the first clamp (209), and another edge which is attached at a perpendicular angle along the median of the underside of the surface (211) of the second handle.

The flexible line (107) extends from where it passes through the hollow core of the first clamp (209) back through the second hole (217) in the surface of the second handle and terminates with an end cap (111).

At the end of the stem of the threaded stud furthest from the first handle, the second clamp (109) is attached to the flexible line (107) by virtue of crimping or welding. The second clamp (109) has a cylindrical shape and a hollow core whose inner wall is attached to the outer surface of one end of a coil spring (108). The surface area of the other end of the coil spring (108) is attached to the inner wall of a hollow cylindrical stem portion (104) of an anchor. The anchor has a flange portion (105) which is circular in shape and extends outward at a perpendicular angle from the end of the stem portion (104) furthest from the coil spring (108). The flange portion (105) of the anchor has a diameter greater than the diameter of the hole bored through the gatepost (112). The portion of flexible line (107) that extends through the hole (112) in the gatepost extends from the threaded stud (102), through the hollow core of the second clamp (109), through the center of the coil spring (108), through the core of the stem (104) of the anchor, and out through the hollow center of the flange portion (105) of the anchor, where it continues (107) to the second handle.

### Operation—FIG. 2

FIG. 2 illustrates the movement of operation for the embodiment illustrated in FIG. 1. In its closed position, with the cylindrical stem portion of the anchor (104) inserted into the gatepost hole (112), the flange portion (105) of the anchor is held in place against the gatepost (118) by the tension of the coil spring (108), which is connected at one end to the cylindrical stem portion (104) of the anchor, and to the flexible line (107) at the other end via the second clamp (109). As such, when the first handle (100) is pulled away (119) from the circular flange portion of the anchor (105), the coil spring (108) tension increases as it becomes stretched into an extended state (121) by oppositional force transmitted from the flexible line (107) to said coil spring via the second clamp (109) which the coil spring is attached to. The flexible line portion between the flange portion of anchor and the second handle is pulled (122) through the hollow core of the cylindrical stem said anchor (104), which causes the length of flexible line (107) remaining between the flange portion of the anchor (105) and the first clamp (209) to be reduced. As a result of the motion (119), with the second handle attached to a gate latch lever (115), the gate latch lever (115) is pulled up into its open position, allowing the gate bar (114) to move freely away from the gate latch.

When the first handle (100) is released, the tension of the coil spring (108) pulls the coil spring back to its retracted state. As the coil spring returns to its compressed, resting state, it pulls the flexible line (107) back into its original position, which causes the gate latch lever (115) to push back into its closed position.

When the surface area of the second handle (211) is pushed (122) forward toward the flange portion of the anchor (105), the gate latch lever (115) to which it is attached is pushed into its open, upright position. In addition, the set of motions described in FIG. 2 are invoked; the flexible line portion (107) which is attached to the first clamp (209) that is embedded in the body of the second handle pushes the flexible line (107) through the hollow core of the flange, which in turn pushes the portion of flexible line (107) and the first handle (119) outward. As a result, the coil spring is stretched into an extended state (121), because on one end it is clamped to flexible line (107) by the second clamp (109) and as a result is pulled away from where it is attached on its other end to the cylindrical stem portion (104) of the anchor.

When the second handle is released, the coil spring (108) retracts, pulling the flexible line (107) back to its original position, and pushing on the portion of flexible line (107) between the flange portion (105) of the anchor and the second handle back to its original position. The gate latch lever (115) is pushed back into a closed position because the screw (215) and bolt (216) bind the trapezoidal body portion of the second handle to the gate latch lever (115).

FIG. 5 shows an alternate embodiment of the mechanism, wherein all components match those described in FIG. 4, with exception to the second clamp (109), which in this embodiment is set apart from the stem portion of the threaded stud (103) and has a threaded hole through its body at a perpendicular angle which is mounted with a threaded screw (113). The screw (113) is tightened so that its length extends though the body of the second clamp (109), binding it to the flexible line (107).

FIG. 6 illustrates the coil spring assembly embodiment described above in FIGS. 1, 3 and 4, wherein the second clamp (109) has a cylindrical shape and a hollow core whose inner wall is attached to the outer surface of one end of a coil spring (108). The surface area of the other end of the coil spring (108) is attached to the inner wall of a hollow cylindrical stem portion (104) of an anchor. The anchor has a flange portion (105) which has a circular shape and extends outward at a perpendicular angle from the stem portion (104).

FIG. 7 illustrates an alternate embodiment of the coil spring assembly of FIG. 6, wherein the second clamp (109) includes a threaded hole through its body at a perpendicular angle that is mounted with a matching threaded screw (113). The second clamp has a cylindrical shape with a hollow core whose inner wall is attached to the outer surface of one end of a coil spring (108). The surface area of the other end of the coil spring (108) is attached to the inner wall of a hollow cylindrical stem portion (104) of an anchor. The anchor has a flange portion (105) which extends outward at a perpendicular angle from its stem portion (104).

FIGS. 8, 9A, 9B, 9C and 9D illustrate components of an embodiment of the second handle. FIG. 8 is an exploded view of the components of this second handle embodiment. Herein, the first clamp (209) has a cylindrical shape and is at the center of a second handle. A flat surface area (211) runs the length of the second handle and is wide enough to be suitable for pushing with one's thumb. The surface area portion (211) of the second handle is an elongated plate with two holes through its face which are the same diameter as the hollow core of the first clamp (209). The first hole is positioned at one end of the surface area (211) plate and is aligned with and connected to the cylindrical rim of the first clamp (209), and the second hole (217) is positioned at the other end of the surface area (211) plate. The second handle has an underside surface (212) comprised of an elongated plate with a single hole through its face, which is the same diameter as the rim of the hollow cylindrical inner core of the first clamp (209), to which the hole in the underside surface (212) is aligned with and connected to. A trapezoidal body portion (213) has a first edge which is attached to the length of the outer wall of the first clamp (209), and second and third edges which are attached along the length of the median of the interior walls of the surface area (211) plate and underside (212) plate portions of the second handle. The trapezoidal body portion (213) has an elongated hole (218) along its fourth edge which is fastened to a gate latch lever (115) with a screw (215) and bolt (216). The second handle also has a triangular body portion (214), the first edge of which is attached to the length of the first cylindrical clamp (209), and another edge which is attached along the length of the median of the underside surface (211) plate.

### Advantages

Evident from the description herein, there are several advantages to these embodiments of my mechanism for operating a gate latch lever:
a. The mechanism can be shipped in its fully assembled state and installed onto a gate latch with simple tools by an average homeowner without requiring employment of a professional contractor.
b. The simple construction makes it easy to manufacture.
c. The simple design lends itself well to manufacturing with different materials, as described in one embodiment which uses stainless steel for all parts.
d. The mechanism improves a gate latch lever by enabling one to use a handle to open the gate latch lever from either side of the gate without having to reach over the fence.
e. The mechanism design is environmentally friendly in that it can be manufactured from recycled and recyclable materials such as steel.
f. The screws and bolts can be made from standard parts that can be easily replaced if lost.
g. The first handle can be replaced by any handle that has matching female threading, enabling one to customize the look as desired.

### CONCLUSION, RAMIFICATIONS AND SCOPE

Accordingly, the reader will see that the mechanism for operating a gate latch lever:
adapts to industry-standard gate latches that have a vertical gate latch lever;
is simple and compact, and as such is economical to produce;
can be shipped in its fully assembled state to customers, making it easy to install with standard tools, making it economical to install for do-it-yourselfers;
can be manufactured as an environmentally friendly product in that it can be made from recycled and recyclable materials such as stainless steel
the compact nature of the coil spring assembly requires only a small hole through the gatepost as it only needs to be as wide as the diameter of the coil spring assembly that surrounds the flexible line;
enables a person to use one hand to open the gate latch lever from either side of the fence;
improves the gate latch lever's return so that it will catch the gate bar when the gate is closed too quickly for a gate latch lever to catch the gate bar, which improves the experience of opening and closing the gate.

Although the description herein contains many specificities, these should not be construed as limiting the scope of the embodiments. For example, some components of the mechanism for operating a gate latch can be made from other sustainable materials, such as bamboo fiber, and the handles can have other shapes. For example, the first handle could be made from cut glass, porcelain, aluminum, bamboo fiber, wood or any other material that can be used to make a knob and can be in any shape suitable for use as a knob. The second handle can also be made from other materials such as bamboo fiber and can have other shapes which provide the same core function of attaching the flexible line to the gate latch lever and providing a second handle that one can push to move the gate latch lever into its open position.

I claim:

1. A mechanism for operating a gate latch lever, comprised of:
a. a flexible line whose length spans the distance from an outer edge of a gate latch lever of an existing gate latch, to the opposite side of a gatepost to which said gate latch is affixed, where said gatepost has a hole bored horizontally through it to accommodate said flexible line;
b. a first handle which has a shape suitable for gripping and pulling with one hand and provides a means for binding to one end of said flexible line;
c. a first clamp element which provides a means for binding said flexible line to said gate latch lever;
d. an anchor which has a hollow stem portion through which said flexible line fits, where said stem portion fits into said hole in said gatepost, and a flange portion through which said flexible line fits, which provides a means bracing said anchor against the face of said gatepost;
e. a second clamp which fits into said hole in said gatepost and provides means to bind said flexible line;
f. a coil spring which fits lengthwise into said hole in said gatepost and has a means for attaching to said second cylindrical clamp and to said stem portion of said anchor;
wherein, with said flexible line extending from where it is attached to said first handle, and then extending through said second clamp which binds it, and then further extending freely through the hollow core of said coil spring and then extending freely through said stem of said anchor and then extending freely out through the middle of said flange portion of said anchor, and then extending a length equal to the distance between said gatepost and said gate latch lever and then finally extending through said first clamp, which binds it.

2. The first clamp of claim 1, wherein the first clamp has a hollow, cylindrical body through which said flexible line fits, and a threaded hole through its side mounted with a screw such that said screw extends through said first clamp's body and binds it to said flexible line.

3. The second clamp claim 1, wherein the second clamp has a hollow, cylindrical body through which said flexible line fits, and a threaded hole through its side mounted with a screw such that said screw extends through said second clamp's body and binds it to said flexible line.

4. The first handle of claim 1, wherein the first handle has a stem portion which provides a means for attaching to said flexible line.

5. The first handle of claim 4 wherein said stem portion's central core has female threading which fits a threaded stud attached to the terminus of said flexible line.

6. The first clamp of claim 1, wherein the first clamp is embedded into the body portion of a second handle, and where said first clamp provides a means for binding said flexible line to said second handle, and said second handle has a surface area on one side suitable for pushing with a thumb and has a body portion which provides a means for attaching to said gate latch lever;

7. The second handle of claim 6, wherein the second handle's body portion is of a shape and size such that it aligns with the top portion of said gate latch lever, and said body portion of said second handle has a means for attaching to said gate latch lever.

8. The second handle of claim 7, wherein a screw passes through a hole in both the body portion of said second handle and said top portion of said gate latch lever, and said screw is fastened with a bolt such that it secures said second handle to said gate latch lever.

9. The flexible line of claim 1, wherein the flexible line provides a is comprised of a semi-rigid material whose rigidity provides means for holding its shape when said second handle is pushed.

10. The flexible line of claim 9, wherein the flexible line is comprised of stainless steel wire rope.

11. The flexible line of claim 1, wherein the flexible line is comprised of a highly flexible material which becomes slack and folds downward when the second handle is pushed.

12. The anchor of claim 1, wherein said anchor's flange portion extends outwardly from the rim of one end of said stem portion, and has a surface wider than said hole through said gatepost;

13. The anchor of claim 12, wherein said flange has a circular shape with a hollow center which accommodates said flexible line, where said hollow center is aligned over said stem portion's hollow center.

14. The second clamp of claim 13, wherein said clamp has a hollow core such that it is open at both ends and has inner and outer surface diameters equal to the inner and outer surface diameters of said stem portion of said anchor, and provides means to bind said flexible line;

15. The coil spring of claim 14, wherein said coil spring's helical shape has an outer diameter matching the inner diameter of said stem of said anchor such that one end of said coil spring is inserted into and is attached to the inner surface of said stem of said anchor and the opposite end of said coil spring is inserted into and attached to the inner surface of said second cylindrical clamp;
